(19) United States
(12) Patent Application Publication
(10) Pub. No.: US 2019/0315240 A1
(43) Pub. Date: Oct. 17, 2019

(54) Method and Apparatus for Parking Space based Autonomous Charging System

(71) Applicant: Elleway Wu, Cupertino, CA (US)

(72) Inventor: Elleway Wu, Cupertino, CA (US)

(21) Appl. No.: 16/383,475

(22) Filed: Apr. 12, 2019

Related U.S. Application Data
(60) Provisional application No. 62/656,863, filed on Apr. 12, 2018.

(51) Int. Cl. B60L 53/16; H02J 7/00; B60L 53/65; G05D 1/02

(52) U.S. Cl. CPC B60L 53/16; H02J 7/0045; B60L 53/65; G05D 2201/02; G05D 1/0234; G05D 1/0225; G05D 1/0242

(57) ABSTRACT

An autonomous electric vehicle charger is disclosed. The autonomous electric vehicle charger comprises a charging robot configured to automatically seek an electric vehicle for charging wherein the charging robot includes a plurality of motorized wheels configured to maneuver the charging robot, a plurality of sensors configured to guide the charging robot, a charging plug configured to be coupled to a receptacle for charging the electric vehicle, an elevated charging platform configured to be raised for coupling the charging plug to the receptacle for charging the electric vehicle, and a retractable power cord configured to be coupled to a power supply for supplying power to the electric vehicle.

### CROSS REFERENCE

This application claims priority from provisional patent application entitled “Method, Apparatus, and System for Charging an Electric Vehicle” filed on Apr. 12, 2018 and having application No. 62/656,863. Said application and any other referenced patents or patent applications herein are incorporated in its entirety by reference.

### FIELD OF INVENTION

The disclosure generally relates to car chargers, and more particularly relates to an autonomous electric or hybrid vehicle charger.

### BACKGROUND

Battery powered or electric vehicles are becoming more and more ubiquitous as consumers seek more eco-friendly alternatives to gasoline powered vehicles. A major challenge with battery powered or electric vehicles is maintaining a sufficient charge to the batteries of the electrical vehicle after reaching the destination or arriving back home. Typically, owners of electrical vehicles need to physically connect a charging cord to their electrical vehicle to charge the battery. The extra step of retrieving the power cord, connecting the power connector to a charging port, and activating the charger is not only time consuming but takes away from the spontaneity that car owners have been accustomed. For example, if there are groceries or other items that are also being transported, the user would need to allocate extra time and effort to ensure that the electrical vehicle is being charged in between trips.

Ensuring the electric vehicle is being charged when not in use is important since it often take an exceeding amount of time to charge the battery compared with operating the electrical vehicle and discharging the battery. Stated differently, it can take 12 or more hours to fully charge a battery of an electric vehicle whereas it may only take a couple hours to fully deplete the battery of the electric vehicle. In order to make owning electrical vehicles more appealing and less distractive, what is needed is an automated apparatus, method, and system that overcomes the burdensome tasks of having to physically retrieve the heavy electrical wire and plug, ensure proper connection of the plug, activate a charging sequence for charging the battery of the electrical vehicle, and later disconnect the connection to the plug, and stow away the heavy electrical wire and plug.

### SUMMARY OF THE INVENTION

A novel method and apparatus for parking space based autonomous charging is disclosed. A designated electric vehicle is paired to securely communicate with a charging robot. A charging robot is in standby awaiting a designated electric vehicle. As a designated electric vehicle comes within communication range of the charging robot, the charging robot verifies user authentication and receives charging commands. Once the electric vehicle has parked, the charging robot verifies that the electric vehicle motor is not active. The charging robot moves to the location of the parked electric vehicle and aligns itself with a charging receptacle of the electric vehicle. After proper alignment, the charging robot raises the elevated charging platform to electrically couple a charging plug with the charging receptacle of the electric vehicle. Once charging is complete, the charging robot retracts the elevated charging platform to disconnect from the electric vehicle. The charging robot records the charging history and returns to base station for standby.

In an aspect of the present invention, the base station is coupled to a power supply, and the base station is electrically coupled to the charging robot and provides power to the charging robot for charging the electric vehicle.

In another aspect of the present invention, the base station is coupled to a 240v power supply.

In yet another aspect of the present invention, the base station is coupled to an electrical outlet of a certain voltage level, e.g. 110v or 220v. An advantage of using an electrical outlet is that it affords more flexibility in the placement of the base station to ensure that the charging robot is not impeded from accessing the electric vehicle to be charged.

In yet another aspect of the present invention, the charging robot includes at least one camera that is activated to ensure proper alignment is achieved between the charging plug and the charging receptacle.

In yet another aspect of the present invention, the charging robot includes a 240v outlet.

In yet another aspect of the present invention, the charging robot includes a 210v outlet.

### DESCRIPTION OF THE DRAWINGS

The foregoing and other aspects of the disclosure can be better understood from the following detailed description of the embodiments when taken in conjunction with the accompanying drawings.

FIG. 1 illustrates an automated charging apparatus in accordance to an embodiment of the present invention.

FIG. 2 illustrates an embodiment of a charging robot in accordance to an embodiment of the present invention.

FIG. 3 illustrates a top view of the charging robot in accordance to an embodiment of the present invention.

FIG. 4 illustrates the charging robot with the elevated charging platform extended for connection to a receptacle of an electric vehicle.

FIG. 5 is a flow diagram of an autonomous charging system in accordance to an embodiment of the present invention.

FIG. 6 illustrates one placement of a power bus across several parking space for use by one or more charging robots.

### DETAILED DESCRIPTION OF THE EMBODIMENTS

In the following detailed description of the embodiments, reference is made to the accompanying drawings, which form a part hereof, and in which is shown by way of illustration of specific embodiments in which the disclosure may be practiced. The present disclosure may, however, be embodied in different forms and should not be construed as limited to the embodiments set forth herein. It is also appreciated that the terms such as “first”, “second”, “third”, etc. are used to distinguish between elements such terms describe. These terms are not necessarily intended to indicate temporal or prioritization of such elements, unless otherwise explicitly stated. Throughout the detailed description, references made to battery can include a single large battery or multiple smaller batteries.

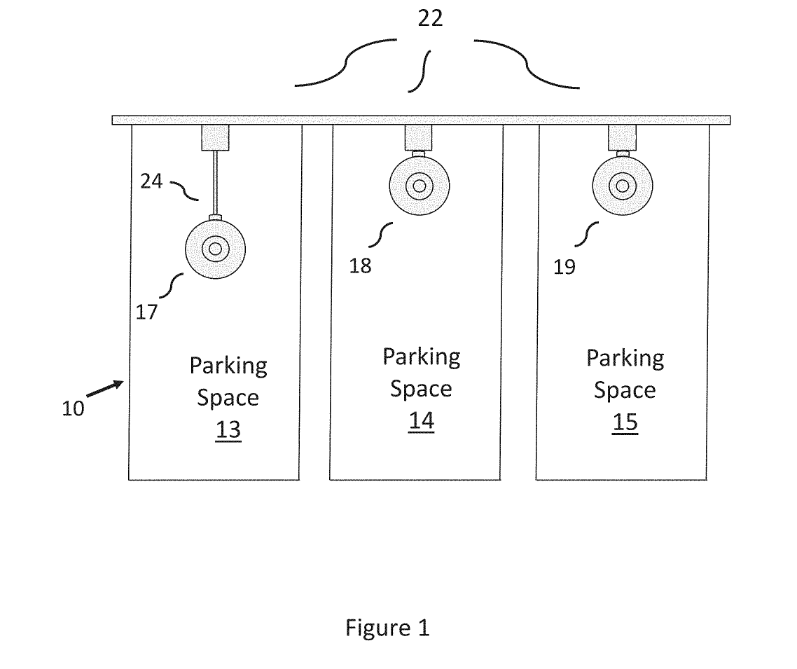

A park and forget concept is based on an autonomous charging system having a charging robot that automatically detects and seeks out a parked vehicle for charging. The charging robot automatically connects to the charging receptacle of the vehicle to be charged and begins charging. Upon completion, the charging robot automatically disconnects from the charging receptacle and returns to its base station. FIG. 1 illustrates an automated charging apparatus 10 in accordance to an embodiment of the present invention with three parking spaces 13, 14, and 15 for three potential electrical vehicles. Each parking space 13, 14, 15, includes a corresponding charging robot 17, 18, and 19 and a corresponding base station 22. The charging robot 17 is shown extended away from the base station 22 with a retractable power cord 24.

In operation, before the electric vehicle (not shown) leaves the parking space 13, the electrical vehicle has already established a secure communication link with the charging robot using a wireless Bluetooth signal, for example. In accordance to an embodiment of the present invention, the charging robot 17 is constantly sending a Bluetooth signal to ensure that the charging robot 17 can automatically pair with the electric vehicle once the electric vehicle is within range of the Bluetooth signal from the charging robot 17. As the electric vehicle nears its parking space, the electric vehicle detects the charging robot via the Bluetooth signal and sends a wireless charging request command to the charging robot 17. At the same time, the electric vehicle opens a door of a charging receptacle under the electric vehicle. The charging command from the vehicle includes the electrical vehicle's user authentication information and charging commands based the vehicle's current battery electrical level. Moreover, the charging commands can be manually set using an interface of the electrical vehicle, set by wireless mobile device, or home computer coupled to an authenticated wireless home network. If user authentication fails or no charging commands are issued to the charging robot 17, the charging robot remains at base station and continues to be in standby. Once user authentication of the electrical vehicle is verified and there is an authenticated charging command received by the charging robot 17, the charging robot begins operation for a charging sequence.

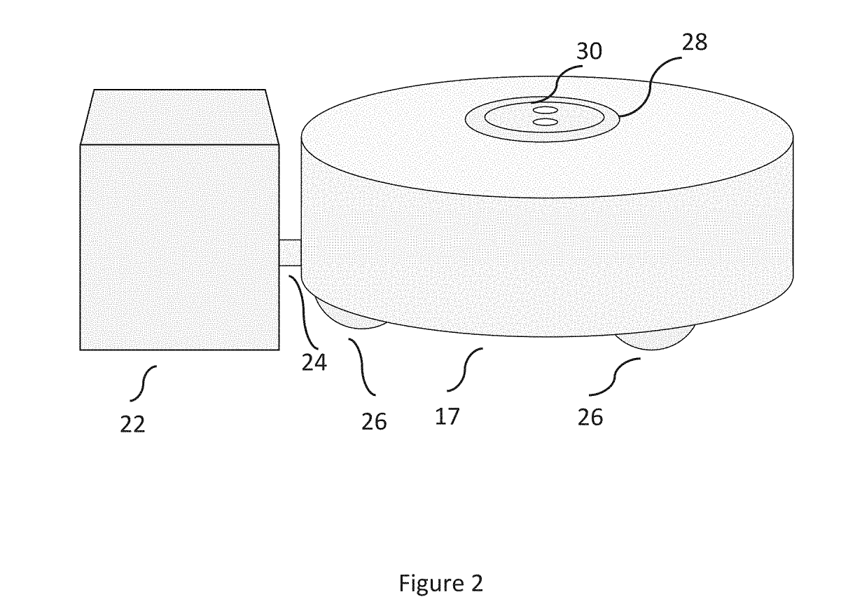

FIG. 2 illustrates an embodiment of a charging robot in accordance to an embodiment of the present invention. The charging robot 17 is attached to a base station 22 via a retractable power cord 24. The charging robot 17 has motorized wheels to enable the charging robot 17 to maneuver. There is an elevated charging platform 28 that can be raised to enable a charging plug 30 to attach to the charging receptacle of the electric vehicle. The charging plug is an electrical plug configured to couple with the charging receptacle of the electric vehicle. Both charging plug and charging receptacle can be made with industry standard design or customized to perform the electrical connections. Moreover, the hardware, firmware, and software to operate the charging robot 17 can be further customized and upgraded.

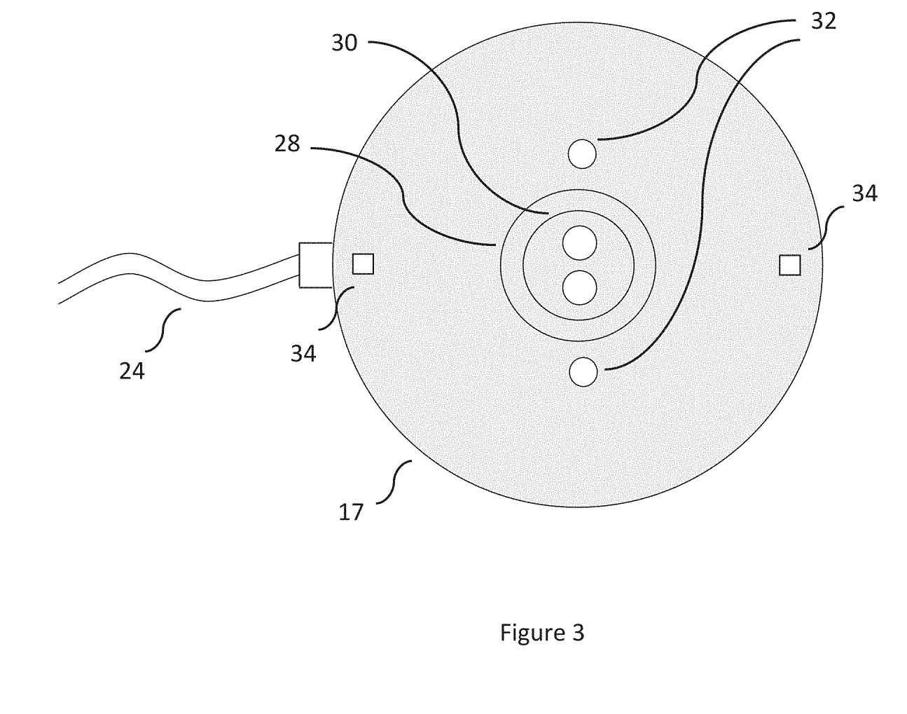

FIG. 3 illustrates a top view of the charging robot 17 in accordance to an embodiment of the present invention. From the top view, the charging robot 17 has cameras 32 to aid the charging robot 17 to more precisely maneuver the elevated charging platform 28 and the charging plug 30 for connection to a charging receptacle of an electric vehicle. The charging robot 17 has sensors 34 for guidance. A retractable power cord 24 is used for connection to the base station 22. The charging robot 17 includes electrical circuits, processors, electrical components, sensors, cameras, batteries, firmware, software necessary to operate. The sensors and cameras of the charging robot 17 can detect other moving objects such as cars, bikes, humans, animals, etc. to avoid collisions.

Before the charging robot 17 begins operation of a charging sequence, the charging robot 17 confirms that the electric vehicle motor is not active and is stationary and ready for charging. The charging robot 17 moves away from the base station 22 towards the electric vehicle based on for example an infrared beacon from the electric vehicle that the charging robot 17 detects. As the charging robot 17 moves towards the electric vehicle for charging, the charging robot 17 includes touch sensors to detect obstacles it may encounter and will reverse direction or change paths to avoid the obstacles. Accordingly, the charging robot 17 is able to maneuver to the destination of the charging receptacle for the electric vehicle. As the charging robot 17 moves to a location near the charging receptacle, the charging robot 17 includes cameras to detect an exact location of the charging receptacle and align the charging plug 30 for attachment to the electric vehicle. The charging robot 17 raises the charging plug 30 and the elevated charging platform 28 to attach the charging plug 30 to the electric vehicle.

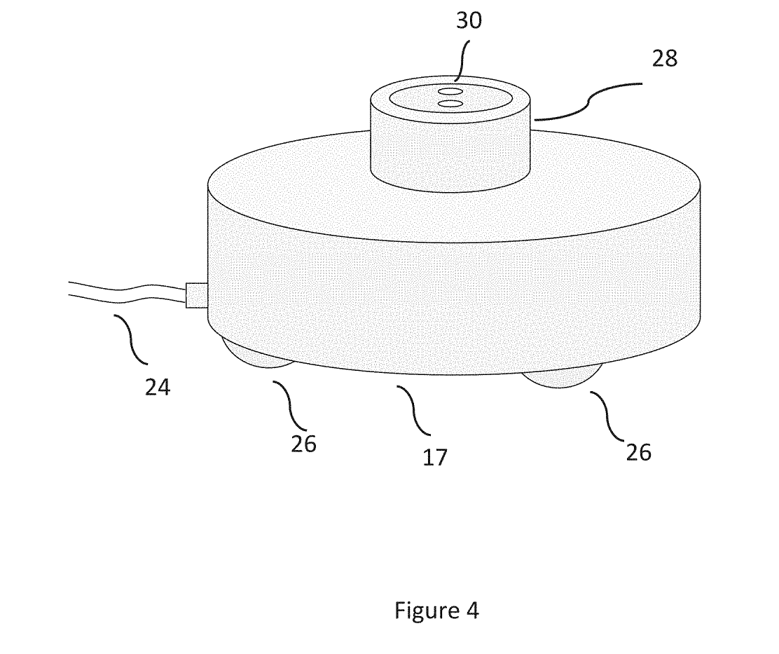

FIG. 4 illustrates an embodiment of the present invention of the charging robot 17 showing the elevated charging platform 28 extended for connection to a charging receptacle of an electric vehicle. The elevated charging platform 28 includes a touch sensor (shown in FIG. 3) to detect the presence of the charging receptacle and stops elevating when the charging plug is coupled with the charging receptacle. Depending on the type of the electric vehicle, the height between the bottoms of different electric vehicles and ground level can be different. In order for the charging robot 17 to be compatible for all electric vehicles, the charging robot 17 and its elevated charging platform can be customized to match electric vehicles with vastly different heights. It should be noted electric vehicle manufacturers can standardize the charging receptacle or customize the charging receptacle for connection to the charging robot 17. The charging robot can also be fitted with customized charging plugs to mate with different electric vehicles.

Once a predetermined time limit has been reached, a desired charge to the battery has been obtained, or other charging parameter has been achieved, the elevated charging platform will disconnect and retracted back into the charging robot 17. Electrical circuits and sensors of the charging robot 17 can detect when the battery is full and will stop charging. An homing signal such as an infrared beacon from base station 22 is activated that the charging robot 17 detects and uses to return back to base station for standby. In an alternative embodiment, as in the case of an apartment complex or commercial property, users of the autonomous charging apparatus can have their electric vehicle charged according to a predetermined payment model, essentially creating a park and forget system. As shown in FIG. 1, the base station 22 provides a retractable power cord connected to the charging robot 17. In accordance to an embodiment of the present invention, the base station 22 can receive a 240v input and provide an output of 240v for output by the charging robot 17. The base station 22 can also be coupled to 120v and includes a power convertor to achieve a 240v output, if needed. The base station 22 can be constructed with a rigid cover to protect the charging plug of the charging robot 17 when the charging robot 17 is in standby. As discussed earlier, the base station 22 has a homing signal such as an infrared beacon transmitter to send signals to the charging robot 17 for return to the base station 22 after a charging cycle. The base station 22 can be placed near and connected to a home power outlet to provide a source of power. The ability to connect to a home power outlet provides added flexibility as to the placement of the base station 22 to further ensure there are less obstructions in the path of the charging robot 17. Note that in embodiments where the retractable cord can be disconnected to allow the charging robot to roam to different base stations, the retractable cord can be stored on the base station side or on the charging robot.

In accordance to an embodiment of the present invention, the electric vehicle includes a computer with a communication link with the charging robot 17. The computer of the electric vehicle includes fail safes that can sense if the electric vehicle's motor is active or inactive or if the electric vehicle is otherwise ready for charging. In a situation where the charging robot is still charging the vehicle and the driver of the electric vehicle may unexpectedly be in an urgent rush to leave, safe guards are in place. When the driver turns on the car, the computer of the electric vehicle senses the electric motor is on and immediately signals to the charging robot to stop charging and retract the elevated charging platform of the charging robot 17. As mentioned previously, the computer of the electric vehicle can be linked and controlled by a mobile app on a wireless mobile device, another remote mobile device, or remote computer to set up the charging sequence automatically after the car is parked based upon the battery charge level or other factors. Other information such as duration before full charge, charging status, charging history, billing, etc. can be accessed and stored on the electric vehicle computer, remote device, wireless mobile device, or cloud.

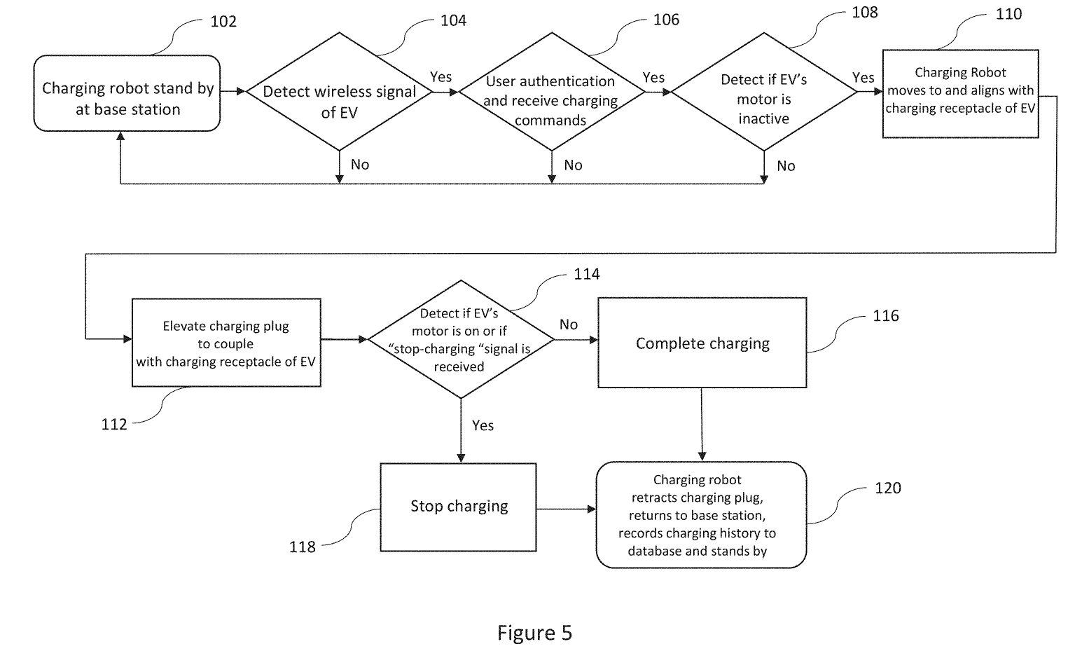

FIG. 5 illustrates a flow chart of an autonomous charging system in accordance to an embodiment of the present invention. Once a designated electric vehicle (EV) has established a communication link with the charging robot 17, the charging robot 17 will recognize the designated electric vehicle when the charging robot 17 and the designated electric vehicle are within range of the communication link. In accordance to an embodiment of the present invention, the communication link is established using Bluetooth. Other types of communication links may be used including radio frequency, or other dedicated communication link. The flow chart begins with step 102. The charging robot 17 is at base station in standby. The charging robot 17 maintains a constant Bluetooth signal in search of the previously established communication link or paired Bluetooth signal from the designated electric vehicle. Next, in decision step 104, the charging robot 17 determines if there is a wireless signal detected from an electric vehicle. If there is no wireless signal detected, the flow returns to the beginning step 102. If there is a wireless signal from an electric vehicle detected in step 104, then the flow moves to decision step 106. If the charging robot 17 determines there is not proper user authentication and no receipt of charging commands, then the flow returns to the beginning step 102. If the charging robot 17 in decision step 106 has proper user authentication and receives charging commands, then the flow moves to step 108. During this step, the designated electric vehicle will open a gate for access to a charging receptacle under the designated electric vehicle. In decision step 108, if the charging robot 17 determines the electric vehicle is still active, then the flow returns to the beginning step 102. If the charging robot 17 determines the electric vehicle is not active, then the flow move to step 110. In step 110, the charging robot 17 moves to and aligns with charging receptacle of the designated electric vehicle for charging. The charging robot detects and is guided by an infrared beacon of the designated electric vehicle. Once near the charging receptacle of the designated electric vehicle, the charging robot 17 uses its cameras for final alignment to the charging receptacle. Next, in step 112, the charging robot 17 raises the elevated charging platform to couple with the charging receptacle of the designated electric vehicle. Next step 114 is a decision step. If the charging robot 17 detects the electric vehicle motor is on or receives “stop charging”, then the flow moves to step 118 to stop charging. Next, the flow ends with step 120. The charging robot 17 retracts the charging plug, returns to base station, records charging history to database and stands by. An infrared beacon from the base station guides the charging robot 17 back to the base station 22. If in decision step 114, the charging robot 17 does not detect the designated electric vehicle motor is on or does not receive a “stop charging” command, the flow move to step 116 to complete charging of the electric vehicle. Once charging is complete, the flow moves to step 120 and ends. The flow of the autonomous charging apparatus can be customized and upgraded to meet a user's requirements. For example, users in an apartment complex or commercial property can have their electric vehicles charged according to a predetermined schedule tied to a payment model to provide a park and forget concept.

In an alternative embodiment, the retractable power cord of the charging robot can be disconnected to allow the charging robot to serve other parking spaces and base stations and thereby extend the range of the charging robot as well as minimizing the number of charging robots needed for a parking garage.

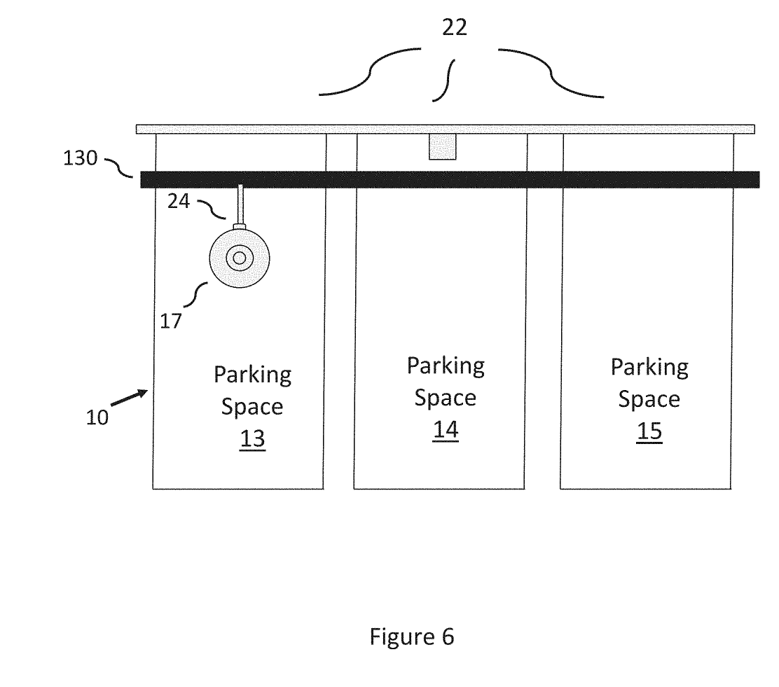

In yet another embodiment, referring to FIG. 6, the base station is replaced with a power bus 130 which can be accessed by the charging robot for power and communication using power over ethernet (POE). The charging robot will not be limited to the location of the base station. Moreover, the base station for the charging robot will be extended to the length of the power bus. The power bus 130 can be a long continuous elongated shape disposed over several parking spaces. In one configuration, the power bus is disposed in such manner such that when a vehicle is parked in a parking space, the power bus is strategically located between the front wheels and the back wheels of the vehicle. In yet another configuration, the power bus is disposed across several parking spaces such that when a vehicle is parked in the parking space, the power bus is in front of the front wheels. A charging robot can then be dispatched to connect to the power bus with its retractable cord and then connect to the vehicle on the other end. The power bus can be connected at one end to a power source. If there are several robots connected to a power bus, power rationing can be performed to prevent overloading the power circuit to the power bus.

While the disclosure has been described with reference to certain embodiments, it is to be understood that the disclosure is not limited to such embodiments. Rather, the disclosure should be understood and construed in its broadest meaning, as reflected by the following claims. Thus, these claims are to be understood as incorporating not only the apparatuses, methods, and systems described herein, but all those other and further alterations and modifications as would be apparent to those of ordinary skilled in the art.

We claim:

1. An autonomous electric vehicle charger comprising:
a charging robot configurable to automatically seek an electric vehicle for charging wherein the charging robot includes:
a plurality of motorized wheels configured to maneuver the charging robot;
a plurality of sensors configured to guide the charging robot;
a charging plug configured to be coupled to a receptacle for charging the electric vehicle;
an charging platform to support the charging plug to the receptacle for charging the electric vehicle; and
a power cord configured to be coupled to a power supply for supplying power to charge the electric vehicle.

2. The autonomous electric vehicle charger of claim 1 further comprising a base station coupled to the power cord of the charging robot configured to provide electrical power to the charging robot.

3. The autonomous electric vehicle charger of claim 2, wherein the base station is coupled to a power source.

4. The autonomous electric vehicle charger of claim 2, wherein the power cord is retractable.

5. The autonomous electric vehicle charger of claim 1, wherein the plurality of sensors of the charging robot includes at least one camera configured to guide the charging plug to the receptacle for establishing an electrical connection.

6. The autonomous electric vehicle charger of claim 1, wherein the charging robot establishes an authenticated communication link with the electric vehicle.

7. The autonomous electric vehicle charger of claim 6, wherein the authenticated communication link is established using Bluetooth.

8. The autonomous electric vehicle charger of claim 1, wherein the charging robot follows an infrared beacon for guidance.

9. The autonomous electric vehicle charger of claim 8, wherein the base station is configured to transmit the infrared beacon.

10. The autonomous electric vehicle charger of claim 1, wherein the charging platform is can be raised.

11. The autonomous electric vehicle charger of claim 1, wherein there is a power bus where one or more of the charging robots can be connected.

12. A method of operating an autonomous electric vehicle charger comprising the steps:
establishing a communication link between a charging robot and an electric vehicle;
authenticating the electric vehicle is authorized to receive a charge from the charging robot;
maneuvering the charging robot to the electric vehicle;
elevating a charging plug to establish an electrical connection to a charging receptacle on the electric vehicle;
charging the electric vehicle to a predetermined charge;
retracting the charging plug to disconnect from the charging receptacle; and
maneuvering the charging robot away from the electric vehicle.

13. The method of operating an autonomous electric vehicle charger of claim 12 further comprising a base station electrically coupled to the charging robot and the step of maneuvering the charging robot away from the electric vehicle includes the step returning the charging robot to the base station.

14. The method of operating an autonomous electric vehicle charger of claim 13, wherein the base station is coupled to a power supply and the method further comprises the step of attaching the base station to a 240v power supply.

15. The method of operating an autonomous electric vehicle charger of claim 13 further comprising the step of activating an infrared beacon from the base station to provide guidance for returning the charging robot to the base station.

16. The method of operating an autonomous electric vehicle charger of claim 12 wherein the step of maneuvering the charging robot to the electric vehicle includes the step of activating an infrared beacon from the electric vehicle to provide guidance to the charging robot.

17. The method of operating an autonomous electric vehicle charger of claim 12 wherein the step of elevating a charging plug to establish an electrical connection to a charging receptacle on the electric vehicle includes the step of activating cameras on the charging robot to align the charging plug with the charging receptacle.

18. The method of operating an autonomous electric vehicle charger of claim 12 wherein the step of elevating a charging plug to establish an electrical connection to a charging receptacle on the electric vehicle includes the step of using sensors to determine when the charging plug has made contact with the charging receptacle.

19. The method of operating an autonomous electric vehicle charger of claim 12 wherein the step of charging the electric vehicle to a predetermined charge includes the step of verifying with the charging robot to determine if there is proper payment for the predetermined charge.

20. The method of operating an autonomous electric vehicle charger of claim 12 wherein the step of detecting the electric vehicle is in proximity of the charging robot includes the step of locating the electric vehicle in a designated parking space.
